(19) United States
(12) Patent Application Publication
(10) Pub. No.: US 2001/0055954 A1
(43) Pub. Date: Dec. 27, 2001

(54) Digital cordless telephone home network

(76) Inventor: Vernon S. Cheng, San Diego, CA (US)

Correspondence Address: LAW OFFICES OF DICK AND HARRIS, 181 West Madison - Suite 3800, Chicago, IL, 60602, US

(21) Appl. No.: 09/821,223

(22) Filed: Mar. 29, 2001

Related U.S. Application Data
(60) Provisional application No. 60/193,403, filed on Mar. 29, 2000.

(51) Int. Cl. H04B 1/40

(52) U.S. Cl. 455/74.1; 455/556; 455/557

(57) ABSTRACT

A wireless home communications network is provided. A digital cordless telephone base unit serves as the hub of the network. The base unit implements a cordless telephone communications protocol incorporating multiple-access features. Telephone calls can be placed on the PSTN through the base unit with a cordless telephone handset. Various other digital electronic devices, such as a home computer, laptop computer, television appliance, portable display tablet, refrigerator with integrated digital display, and PDA, can also use a cordless telephone transceiver to establish wireless data communication links with the base unit. These digital electronic devices can utilize the communication links with the base unit for a variety of functions, including Internet access, email, and grocery list maintenance. Such devices may also include audio input and output capabilities, such that they can also be used for voice telephony via the PSTN.

This application claims the benefit of U.S. Provisional Application No. 60/193,403, filed Mar. 29, 2000.

### BACKGROUND OF THE INVENTION

1. Field of the Invention

This invention relates in general to wireless digital communications. In particular, the invention relates to a wireless digital networking system for the home.

2. Background Art

Cordless telephones have become increasingly popular in recent years, such that they are now a common fixture in the modern household. The functionality of cordless telephones has typically been adapted to voice telephony functions, such as the conduction of voice telephone calls, answering machine services and speciality functions such as Caller ID. Thus, digital data capabilities are typically limited to DTMF keypad signalling, rather than general purpose digital data communications.

Accordingly, cordless telephones have become a relatively high volume, low cost product choice for voice communications, sold through an enormous array of consumer outlets. Moreover, cordless telephones are very price-sensitive products. Due to an absence of common subsidization models enabling a recurring service-based revenue stream to offset the cost of cordless telephone hardware, cordless telephones must generate profits based upon hardware sales alone. Thus, cordless telephone product lines are typically directed to offering the user multiple products with varying features, such that the consumer pays only for desired features. While with the advent of the Internet age there are many new business models that do enable hardware subsidization through subscription and/or advertising revenues, these models have not been widely applied to conventional cordless telephones, and are oftentimes disadvantageous because such models complicate the consumer's purchasing decision.

Nevertheless, modern digital cordless telephones are high-volume, low cost products commonplace in modern homes that support wireless digital communications—often with substantial bandwidths. Thus, it may be desirable to define a low-cost wireless digital network based upon a cordless telephone system. It may further be beneficial in some applications to support additional hardware features through expandability and upgradability, thus keeping the consumer purchase decision relatively simple.

### SUMMARY OF THE INVENTION

A wireless digital communications network is presented that includes a cordless telephone base unit. The base unit incorporates a radiofrequency transceiver capable of establishing wireless digital communication links, a microprocessor circuit, digital storage accessible to the microprocessor circuit, and a telephone line interface that can be connected to a public switched telephone network (“PSTN”). A cordless telephone handset is provided to conduct voice telephone calls on the PSTN. Furthermore, additional electronic devices include RF transceivers capable of communicating digital data according to the cordless telephone communications protocol implemented by the base unit. The base unit, handset and additional devices include unique identification number by which communications can be specifically addressed thereto. Each of these devices may also incorporate encryption mechanisms for securing their respective data communications.

The base unit can include a communications port through which communications with a separate digital network, such as the Internet, can be established. For example, this communications port may consist of a Digital Subscriber Line (“DSL”) modem, through which the base unit can access the Internet or another server. In accordance with one potential aspect of the invention, the communications port may be implemented as an expansion module that can be readily installed into the base unit, as desired, thus allowing for flexible hardware configurations and upgradability. Thus, other types of communications ports can be installed as desired by the user, such as a cable modem, analog data modem for a second PSTN line, wireless ethernet modem, etc.

Any additional electronic devices on the network can utilize the network access resources of the base unit. For example, a PDA equipped with a transceiver capable of communicating with cordless telephone base unit 100 can initiate communication links through which data can be transmitted to and received from the Internet. Such additional electronic devices can also access information storage capabilities of the base unit, thereby enabling the reading and updating of email messages or a master grocery list maintained within the base unit. Additional electronic devices with audio input and output capabilities can also use the wireless interface with base unit 100 to conduct voice telephony via the PSTN. Moreover, a user can utilize the handset or an electronic device to conduct voice telephony via base unit 100, while simultaneously using another electronic device to engage in data communications via the Internet.

### BRIEF DESCRIPTION OF THE DRAWINGS

FIG. 1 is a block diagram of the digital cordless telephone home network.

FIG. 2 is a schematic block diagram of the network base unit.

### DETAILED DESCRIPTION OF THE DRAWINGS

While this invention is susceptible to embodiment in many different forms, there are shown in the drawings and will be described in detail herein several specific embodiments. The present disclosure is to be considered as an exemplification of the principle of the invention intended merely to explain and illustrate the invention, and is not intended to limit the invention in any way to embodiments illustrated.

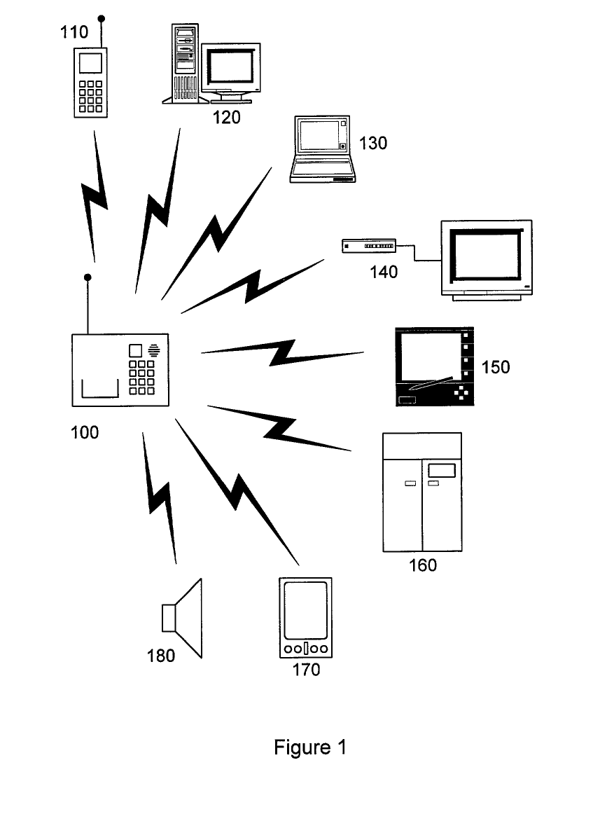

A wireless home network arrangement according to the present invention is illustrated in FIG. 1. The network is centered upon cordless telephone base unit 100. Base unit 100 communicates with cordless telephone handset 110 via a multiple-access digital communications protocol. Many such protocols are known in the cordless telephone art, including DECT, WDCT, and CT2. Alternatively, other digital wireless communications protocols, such as those designed for data communications, can also be utilized for the conduction of telephone calls between handset 110 and base unit 100.

Base unit 100 is also capable of communicating with numerous other devices via the selected wireless digital communications protocol, thereby enabling it to serve as the hub of a wireless home network. For example, the network depicted in FIG. 1 includes communications with personal computer 120, laptop computer 130, television appliance 140, portable display 150, refrigerator 160, PDA 170 and home security system 180. Each device on the home network is assigned a unique device ID, thereby allowing for addressable communications between base unit 100 and each of the devices on the wireless network, 110 through 180.

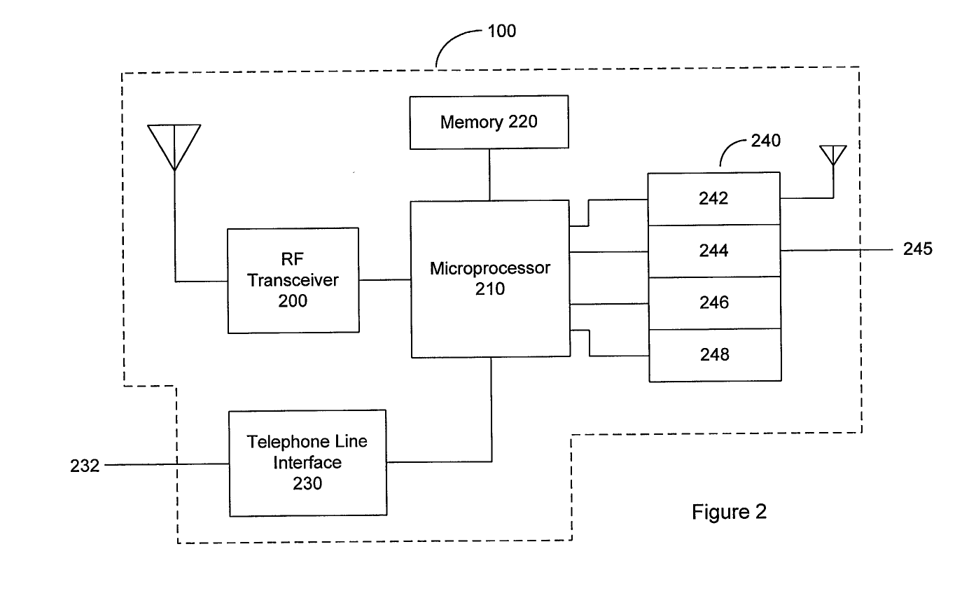

FIG. 2 is a schematic block diagram of one embodiment of base unit 100. Digital signals are received and transmitted between base unit 100 and various components of the wireless network 110 through 180 by radiofrequency transceiver 200. Within base unit 100, the digital signals are bidirectionally communicated between transceiver 200 and central microprocessor circuit 210. Memory 220 is accessible to microprocessor circuit 210 and is provided to implement a number of functions, such as the storage of operational program code for microprocessor circuit 210, the storage of answering machine outgoing message data and incoming messages, and the storage of information as required by various specific features implemented by the user (e.g. email outbox and inbox, grocery list, etc.). Accordingly, memory 220 may be comprised of one or more types of digital storage known in the art, as may be desired for various functions, such as DRAM, SRAM, EEPROM, and/or magnetic media. Telephone line interface 230 is provided to allow for, at a minimum, the implementation of voice telephony between telephone handset 110 and public switched telephone network (“PSTN”) line 232.

Base unit 100 is also provided with expansion slots 242 through 248. The expansion slots provide for a highly flexible system which can be configured to meet a customer's current needs and provide for future upgradability, without requiring the purchase of unnecessary or unwanted hardware. For example, for some users it may be desirable to provide for communications between home network base unit 100 (and optionally various devices connected thereto) and the Internet. Thus, expansion module 244 is provided as a Digital Subscriber Line (“DSL”) modem, allowing for communications between base unit 100 and DSL line 245. Alternatively, a user could select an expansion module designed to provide a different type of connection to the Internet or any other separate digital network. For example, a cable modem module could be provided if the user subscribes to cable modem service. If a user utilizes a second PSTN line for data communications via an analog modem, an analog modem module could be provided for interconnection thereto. Some Internet Service Providers (“ISPs”) require the use of proprietary modem units; thus, expansion module 244 may comprise an Ethernet or Universal Serial Bus communications port, as is required for interconnection with the ISP's particular modem unit.

Microprocessor circuit 210 may utilize a renewable encryption key, such that the data transmitted from or received by the base unit is encrypted for security and privacy. Separate encryption processes can be implemented for communications via both the wired network connections implemented via telephone line 232 or DSL line 245, and for wireless communications between base unit 100 and network devices 110 through 180. Moreover, encryption processes implemented for wireless communications between base unit 100 and network devices 110 through 180 may incorporate encryption keys based upon each device's unique device ID.

Alternatively, microprocessor circuit 210 can implement a software analog modem to conduct data communications with a dial-up ISP through telephone line interface 230 and PSTN connection 232. While this implementation eliminates the need to purchase an expansion module for data communications, it limits the bandwidth available for communications between the base unit and the ISP and prohibits the use of PSTN line 232 for voice communications while data communications are taking place. However, off-line data processing techniques can minimize the resulting inconvenience, as is discussed further below.

While base unit 100 comprises the hub of its own wireless network, in some circumstances a user may desire to provide an interface with a wireless networking standard in addition to that implemented by the base unit as described above. For example, expansion module 242 provides a wireless ethernet link based upon the IEEE 802.11 standard. Laptop computer 130 may be used during the day in an office that implements a wireless LAN based upon the 802.11 standard. By adding expansion module 242 to the user's home network, and configuring the module to operate as an 802.11 hub, the laptop computer can also be brought home and instantly connected to the user's home network, without requiring any cabling to base unit 100 or any other aspect of the user's home network. Alternatively, if a user implements a separate 802.11 network in their home that is connected to the Internet, expansion module 242 can be configured as a network client (rather than the hub). In this configuration, base unit 100 (and the other devices networked thereto) can access the connectivity of the 802.11 network via an 802.11 link through module 242. Moreover, by configuring wireless communications module 242 as an expansion module, modules implementing different or newer wireless communications protocols can also be provided, thereby allowing for expandability and upgradability of base unit 100.

Expansion modules can also be incorporated into various independent electronic devices to provide such devices with a wireless interface to base unit 100 using the communications protocol implemented by cordless telephone handset 110. For example, personal computer 120 includes a transceiver card, with associated software drivers, that plugs into an industry standard PCI expansion slot and can provide an Internet Protocol (“IP”) network connection via the cordless telephone communications link. Alternatively, personal computer 120 could include a stand-alone wireless modem implementing the wireless communications protocol of handset 110, connected via the USB bus or another external expansion port. Laptop computer 130 may be provided with a wireless connection to base unit 100 via one of the aforementioned techniques, or via a PCMCIA module, such as is commonly used for other laptop computer peripherals.

A television set can also be incorporated into the home network by connecting it to a television appliance. Television appliance 140 includes an RF transceiver for communicating with base unit 100 via the cordless telephone communications protocol, as well as video display circuitry for visually displaying information received from base unit 100 on the television screen. A remote control device associated with the television appliance can be used for inputting text or commands, which can in turn be wirelessly transmitted to base unit 100 by appliance 140. Thus, appliance 140 can be used to provide a visual interface to base unit 100, and accordingly with other elements of the home network as well. For example, base unit 100 can provide a visual, menu-driven interface for programming base unit 100 by transmitting text and/or graphical data indicative of the base unit programming state to appliance 140, which data can then be displayed by appliance 140 on the television.

An alternative display device that may comprise a part of a home network is portable display tablet 150. Tablet 150 includes a flat-panel LCD screen for information display, as well as a wireless transceiver implementing the cordless telephone protocol for communications with base unit 100. Tablet 150 may also include a touch-sensitive screen so that a stylus can be used as an input device, such as for the entry of text or the selection of displayed menu items.

Display devices such as television appliance 140 and portable display tablet 150 can be utilized for the provision of email access or access to other Internet contents. In implementing email on such devices, base unit microprocessor circuit 210 can be provided with email client programming, such as POP3 and SMPT functionality known in the art. Storage for incoming and outgoing messages can be allocated within base unit memory 220 for various mailboxes.

The cordless telephone communications protocol can also be utilized to provide a wireless connection with PDA 170. For example, many PDAs include expansion ports, such that a transceiver module and accompanying software could be connected to the PDA to provide a wireless data connection according to the cordless telephone communications protocol. Other PDAs may be designed specifically to include a wireless interface implementing the cordless telephone communications protocol. PDA 170 can therefore be used for functions such as providing a visual interface with base unit 100. PDA 170 can also implement a wireless Internet connection through base unit 100 and, for example, module 244, such as for web surfing or operation as an email client.

Another advantage of the network disclosed herein is that cordless voice telephony can be conducted using devices that are not typically used therefor. For example, many PDAs include microphones and speakers or headphone jacks for audio input and output functionality. Such a PDA, equipped with the wireless data transceiver, can readily be utilized to implement voice telephony, in addition to its other functionality, merely via software implementation, thus eliminating the need to purchase additional hardware specifically for implementing voice telephony. Similarly, typical computers include microphone inputs as well as audio speakers. Thus, personal computer 120 and laptop computer 130 can also be used to conduct reliable, high-quality cordless voice telephony via the PSTN through base unit 100.

In addition to providing flexible voice telephony, base unit 100 also provides real-time Internet connectivity to a wide array of network devices. Through its connection with DSL line 245, IP networking can be wirelessly provided by base unit 100 to personal computer 120, laptop computer 130, display tablet 150 or PDA 170. Television appliance 140 can also include IP networking features such that a television can be utilized as a web browser display. Thus, the user can surf the web, shop, order groceries, check bank accounts, or conduct any other Internet activity from a wide variety of locations within the home.

Another beneficial aspect of the illustrated embodiment of the wireless home network is the ability to conduct cordless voice communications while simultaneously executing data applications when base unit 100 includes a separate Internet connection in addition to PSTN connection 232. For example, a user can speak with a merchant using PDA 170 according to the cordless voice telephony features described above, while simultaneously receiving graphical images of the merchant's products on portable display tablet 150 via Internet connection 245, such as may assist in the user's purchase decision.

Base unit 100 also implements off-line applications that do not require real-time access to the Internet. Base unit 100 can operate as an off-line email client or content client by periodically receiving incoming data or messages from, and periodically transmitting outgoing data or messages to, intended destinations. Thus, incoming messages and data is stored and can later be reviewed on a variety of devices connected to the network, such as personal computer 120, laptop computer 130, television appliance 140, display tablet 150 or PDA 170. Likewise, outgoing email messages or other outgoing data transmissions composed on one of the aforementioned network devices can be stored by base unit 100 for later transmission. Offline functionality can be advantageously implemented, for example, when PSTN telephone line 232 is used for both voice communications and Internet connectivity. When a user finishes compiling outgoing email messages, or desires to check for new incoming email messages, base unit 100 can dial a service provider via software modem functionality and send/receive messages with minimal connection time, thereby leaving the telephone line otherwise free for regular voice telephony.

Base unit 100 can also operate as a storage center for various home management data. For example, refrigerator 160 incorporates a display tablet operating substantially like that of tablet 150. Therefore, for example, when a user in the kitchen of a home notices that a particular item has been depleted, and needs to be purchased during a future shopping trip, the user can conveniently note the required item in a grocery list application via the refrigerator 160 display tablet. The grocery list entry is transmitted to base unit 100 via the cordless telephone communications protocol, and stored in base unit memory 220. In one potential embodiment, the cost of the display device can be minimized by implementing the device as a dumb terminal, such that the display device provides primarily input/output functionality, with data storage and processing occurring within base unit 100. Other network devices can also access the grocery list data within base unit 100, such that the list can be printed before a shopping trip by computer 120, or wirelessly downloaded into PDA 170. The user can also access the list while placing an order for required items via the Internet using an appropriate device on the home network, such as personal computer 120 or display tablet 150.

Base unit 100 can also collect and store desired information for display and use by various network devices. For example, base unit 100 could collect weather forecasts and/or stock quotes via Internet connection 245, for display on the display tablet of refrigerator 160. Targeted advertising and/or discount promotions could also be displayed on various network devices. For example, base unit 100 could be configured to periodically poll Internet web sites specified by the user to check for sales or other promotions in which the user may be interested. If such information is found, it is transmitted to the display tablet in refrigerator 160 for display to the user. When PSTN telephone line 232 is used to place data calls for information downloading, base unit 100 can be configured to call at times when the line is unlikely to be required for voice telephony, such as at 4:00 a.m., thereby minimizing any inconvenience caused by occupation of the telephone line.

The aforementioned automated display of advertisements can also be utilized to implement a business model based upon partial or complete subsidization of user costs through automatic display of advertisements. Specifically, a service provider could contract with various advertisers to advertise their products in the homes of users. Users could then agree to have their base units configured to automatically display such advertisements in return for reduced prices on network hardware and/or reduced rates for various related services, such as Internet service provision.

Base unit 100 may also include a dial-in function, whereby external access to various aspects of the home network can be obtained. For example, a telephone call can be placed to PSTN line 232, such that telephone line interface 230 answers the line. Upon entry of a predetermined access code sequence of DTMF tones, microprocessor circuit 210 may present the user with a voice menu that can be navigated via entries on a touch tone keypad. Through this mechanism, the user can check the status of various devices on the home network. For example, a home security system 180 may be configured with a cordless telephone transceiver and a device ID, such that it resides on the network. Base unit 100 can then query security system 180 to determine the alarm status, and convey commands to the security system to, for example, remotely arm or disarm the alarm. Alternatively, instead of providing dial-in access to the home network via the entry of DTMF tones, base unit 100 could detect modulated signals indicative of a modem data call on line 232, or data corresponding to a remote log in via Internet access line 245, such that a user could remotely control the base unit and other network devices via a remote computer interface.

The foregoing description and drawings merely explain and illustrate the invention and the invention is not limited thereto except insofar as the appended claims are so limited, inasmuch as those skilled in the art, having the present disclosure before them will be able to make modifications and variations therein without departing from the scope of the invention.

I claim:

1. A wireless digital communications network comprised of:
a base unit that includes a first transceiver capable of conducting wireless communications via a cordless telephone communications protocol, a microprocessor circuit operably connected with the first wireless transceiver, digital storage accessible by the microprocessor, and a telephone line interface capable of receiving audio signals from the microprocessor;
a cordless telephone handset, which handset includes a second wireless transceiver capable of conducting voice telephony via the cordless telephone communications protocol with the first transceiver;
a digital electronic device that includes a third wireless transceiver that communicates digital data other than that required for voice telephony with the first transceiver via the cordless telephone communications protocol.

2. The communications network of claim 1, in which the digital electronic device is a general purpose computer system.

3. The communications network of claim 1, in which the digital electronic device is a personal digital assistant.

4. The communications network of claim 3, in which the personal digital assistant is further comprised of an audio input and an audio output, and voice data is routed between the personal digital assistant audio input and output and the base unit telephone line interface, via the third transceiver and the first transceiver, to conduct voice telephony.

5. The communications network of claim 2, in which the computer is further comprised of a microphone for audio input and an audio output, and voice data is routed between the computer microphone and audio output and the base unit telephone line interface, via the third transceiver and the first transceiver, to conduct voice telephony.

6. The communications network of claim 1, in which the digital electronic device further includes an audio input that routes voice data to the third transceiver for transmission to the first transceiver, and an audio output that receives voice data from the third transceiver transmitted by the first transceiver, whereby voice telephony can be conducted with the digital electronic device through the base unit telephone line interface.

7. The communications network of claim 1, in which the base unit is further comprised of a communications port through which the microprocessor communicates with a second digital communications network, whereby digital data communications can occur between the second digital communications network and the digital electronic device.

8. The communications network of claim 7, in which the second network includes connectivity with the Internet.

9. The communications network of claim 7, in which the communications port is disposed on an expansion module that can be alternately installed into or removed from the base unit.

10. The communications network of claim 1, in which the base unit is further comprised of an analog data modem capable of communicating data from the base unit microprocessor to a second digital communications network through the telephone line interface.

11. The communications network of claim 1, in which the base unit is further comprised of means for communicating digital data with a second digital communications network.

12. The communications network of claim 1, in which the base unit, cordless telephone handset and digital electronic device are each associated with a unique device identification number.

13. The communications network of claim 12, in which the data communicated between the first transceiver and third transceiver is encrypted using a variable encryption key.

14. The communications network of claim 1, in which the digital electronic device is further comprised of video display circuit that provides a video signal to a television set indicative of data received by the third transceiver.

15. The communications network of claim 1, in which the digital electronic device is a portable display tablet further comprised of a flat-panel LCD display screen, and a video driver circuit that displays data received from the third transceiver on the LCD display screen.

16. The communications network of claim 7, in which the first wireless transceiver communicates voice data with the second transceiver while simultaneously communicating non-voice data with the third transceiver.

17. The communications network of claim 16, in which the digital electronic device is further comprised of means for displaying data received by the third transceiver.

18. The communications network of claim 11, in which the base unit is further comprised of an email client that receives email from and transmits email to the second digital communications network via the base unit communications port.

19. The communications network of claim 7, in which the base unit is further comprised of a first encryption key for encrypting data transmitted to the digital electronic device, and a second encryption key for encrypting data transmitted to the second communications network.
